(19) United States
(12) Patent Application Publication
(10) Pub. No.: US 2013/0342749 A1
(43) Pub. Date: Dec. 26, 2013

(54) ZOOM LENS AND IMAGE PICKUP APPARATUS HAVING THE SAME

(71) Applicant: Canon Kabushiki Kaisha, Tokyo (JP)

(72) Inventor: Yoshihisa Tashiro, Nikko-shi (JP)

(21) Appl. No.: 13/911,206

(22) Filed: Jun. 6, 2013

(30) Foreign Application Priority Data
Jun. 21, 2012 (JP) 2012-139649
Apr. 30, 2013 (JP) 2013-096004

(51) Int. Cl. G02B 13/00

(52) U.S. Cl. CPC G02B 13/009
USPC 348/345; 359/689

(57) ABSTRACT

A zoom lens includes, in order from an object side to an image side, a first lens unit having a negative refractive power, a second lens unit having a positive refractive power, and a third lens unit having a negative refractive power. Each distance between two adjacent lens units varies during at least one of zooming and focusing. The first lens unit and the second lens unit move during zooming so that a distance between the first lens unit and the second lens unit at a telephoto end is shorter than that at a wide-angle end. The third lens unit moves during the focusing. Each lens unit includes at least one positive lens and at least one negative lens. Predetermined conditions are satisfied.

### BACKGROUND OF THE INVENTION

1. Field of the Invention

The present invention relates generally to a zoom lens, and more particularly to a zoom lens suitable for an image pickup apparatus, such as a video camera, a digital still camera, a TV camera, and a surveillance camera.

2. Description of the Related Art

An image pickup apparatus, such as a digital still camera and a video camera, requires a zoom lens having a wide angle of view and a high zoom ratio. A zoom lens having a shallow depth of field is also demanded for the photography of making an object prominent by blurring the background. Moreover, an image pickup apparatus that uses a solid state image sensor needs a zoom lens having good telecentricity on the image side so as to avoid shading.

In particular, an image pickup apparatus to be made small, such as a compact digital camera, uses an image sensor as small as about 1/2.3 type to about 1/1.7 type for the telecentricity of the zoom lens and the miniaturization of the image pickup apparatus. Since this zoom lens has a lens system in which an actual focal length is short, a captured image has a deep depth of field. As the sensor size becomes larger for a wider blur expression, the entire optical system becomes larger if the telecentricity of the zoom lens is maintained.

A compact digital camera using a solid state image sensor generally calculates the contract of the object based upon an output of the image sensor for focusing of the image pickup optical system. In order to search a peak position of the contrast of the image, the focus lens is wobbled in the optical axis direction. A small and lightweight focus lens unit is demanded for fast focusing.

A three-unit zoom lens that includes, in order from the object side to the image side, three lens units having negative, positive, and negative refractive powers is known as a zoom lens applicable to a large image sensor in a small overall system (Japanese Patent Laid-Open Nos. 05-093866 and 2006-119193). A negative lead type three-unit zoom lens that includes a front lens unit having a negative refractive power utilizes a telephoto type having strong refractive powers of the second lens unit and the third lens unit for a small back focus, a small overall lens length, and a compact overall system.

The distortion of the optical system can be corrected through digital processing in an image pickup apparatus using a solid state image sensor. A large solid state image sensor can enlarge its allowable ray incident angle through the optimization of the on-chip micro lens arrangement.

For a compact overall system and an oblique incident angle of a light flux upon an image plane in the negative lead type three-unit zoom lens, it is important to properly set a lens configuration of each lens unit and a refractive power of each lens unit etc. For example, it is important to properly set the refractive powers of the first and third lens units, the lens configuration of the first lens unit, and the back focus. The improper configuration has difficulties in the compact overall system, the oblique incidence of the light flux upon the image plane, and the high optical performance.

JP 05-093866 discloses a zoom lens having half an image pickup angle of field of about 35° and a zoom ratio of about 3. This zoom lens is used for a film-based camera, and the distortion is corrected down to ±5% from the wide-angle end to the telephoto end. In the correction of the distortion, the negative distortion generated in the first lens unit is canceled by the positive distortion generated in the third lens unit.

Since the refractive power of the first lens is made stronger for a small front effective diameter, a curvature of field at the wide-angle end is likely to increase. Furthermore, the refractive power of the third lens is made stronger in order to correct the distortion, and it tends to be difficult to correct a variety of aberrations in the overall zoom range.

JP 2006-119193 discloses a zoom lens having an image pickup angle of view of about 30° and a zoom ratio of about 2. The zoom lens is compatible with a small image sensor, and has a comparatively small overall system. The back focus at the wide-angle end is reduced for the compact overall system. When the small third lens unit is set to a focusing unit, it is difficult to secure a moving amount of the focus lens unit at the wide-angle end due to the excessively short back focus. In addition, the third lens unit arranged near the image plane at the wide-angle end increases an effective diameter of the final lens unit as the zoom lens is made larger with the sensor size.

### SUMMARY OF THE INVENTION

The present invention provides a zoom lens that has a small overall system and can obtain good optical performance with a high incident angle of a light flux upon an image plane.

A zoom lens according to the present invention includes, in order from an object side to an image side, a first lens unit having a negative refractive power, a second lens unit having a positive refractive power, and a third lens unit having a negative refractive power. Each distance between two adjacent lens units varies during at least one of zooming and focusing. The first lens unit and the second lens unit move during zooming so that a distance between the first lens unit and the second lens unit at a telephoto end is shorter than that at a wide-angle end. The third lens unit moves during the focusing. Each lens unit includes at least one positive lens and at least one negative lens. All of the following conditional expressions are satisfied:

0.7<f1/f3<1.2;

2.5<|f3|/skw<6.0; and

1.5<|f1|/fw<2.40,

where f1 is a focal length of the first lens unit, f3 is a focal length of the third lens unit, skw is a back focus at the wide-angle end, and fw is a focal length of an entire system at the wide-angle end.

Further features of the present invention will become apparent from the following description of exemplary embodiments with reference to the attached drawings.

### BRIEF DESCRIPTION OF THE DRAWINGS

FIG. 1 is a lens sectional view at a wide-angle end according to a first embodiment.

FIGS. 2A, 2B, and 2C are longitudinal aberrational diagrams at a wide-angle end, an intermediate zoom position, and a telephoto end when an infinitely distant object (infinite object) is brought into an in-focus according to the first embodiment.

FIGS. 3A, 3B, and 3C are longitudinal aberrational diagrams at a wide-angle end, an intermediate zoom position, and a telephoto end when a finitely distant object is brought into an in-focus according to the first embodiment.

FIG. 4 is a lens sectional view at a wide-angle end according to a second embodiment.

FIGS. 5A, 5B, and 5C are longitudinal aberrational diagrams at a wide-angle end, an intermediate zoom position, and a telephoto end when an infinite object is brought into an in-focus according to the second embodiment.

FIGS. 6A, 6B, and 6C are longitudinal aberrational diagrams at a wide-angle end, an intermediate zoom position, and a telephoto end when a finitely distant object is brought into an in-focus according to the second embodiment.

FIG. 7 is a lens sectional view at a wide-angle end according to a third embodiment.

FIGS. 8A, 8B, and 8C are longitudinal aberrational diagrams at a wide-angle end, an intermediate zoom position, and a telephoto end when an infinite object is brought into an in-focus according to the third embodiment.

FIGS. 9A, 9B, and 9C are longitudinal aberrational diagrams at a wide-angle end, an intermediate zoom position, and a telephoto end when a finitely distant object is brought into an in-focus according to the third embodiment.

FIG. 10 is a lens sectional view at a wide-angle end according to a fourth embodiment.

FIGS. 11A, 11B, and 11C are longitudinal aberrational diagrams at a wide-angle end, an intermediate zoom position, and a telephoto end when an infinite object is brought into an in-focus according to the fourth embodiment.

FIGS. 12A, 12B, and 12C are longitudinal aberrational diagrams at a wide-angle end, an intermediate zoom position, and a telephoto end when a finitely distant object is brought into an in-focus according to the fourth embodiment.

FIG. 13 is a schematic view of a principal part of an image pickup apparatus according to the present invention.

### DESCRIPTION OF THE EMBODIMENTS

A description will be given of the embodiments of the present invention with reference to the accompanying drawings.

A zoom lens according to the present invention includes, in order from an object side to an image side, a first lens unit having a negative refractive power, a second lens unit having a positive refractive power, and a third lens unit having a negative refractive power. Each distance between two adjacent lens units varies during at least one of zooming and focusing. During zooming from the wide-angle end to the telephoto end, the first lens unit L1 and the second lens unit L2 move so that a distance between them reduces and the third lens moves during focusing.

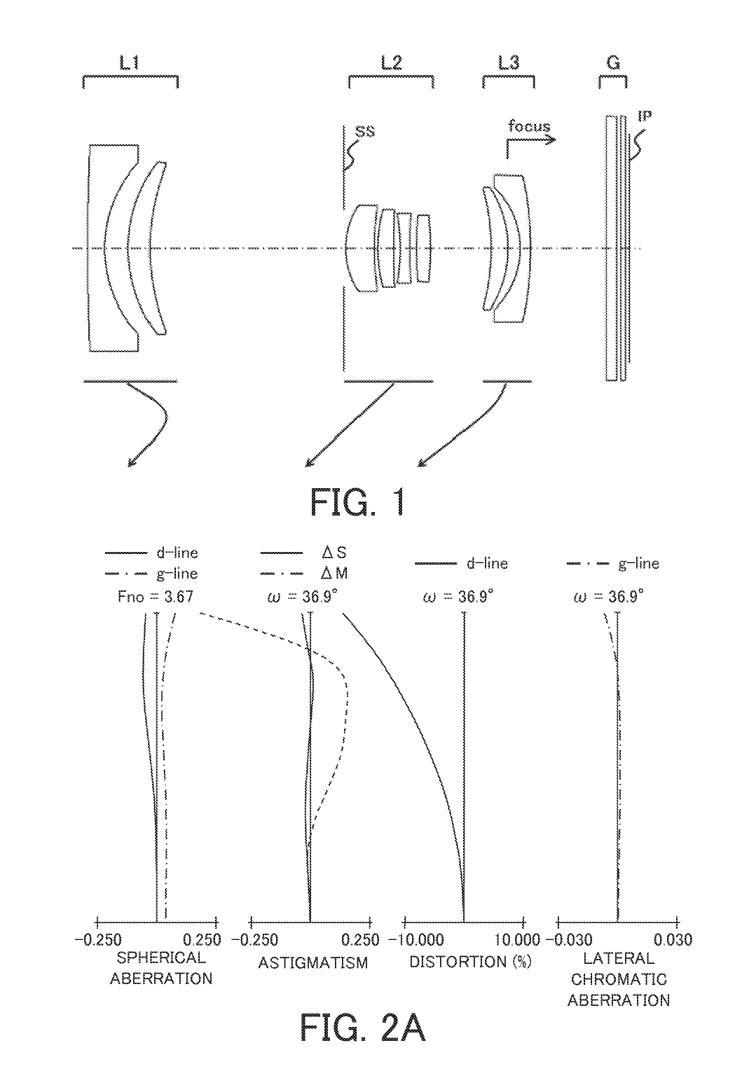

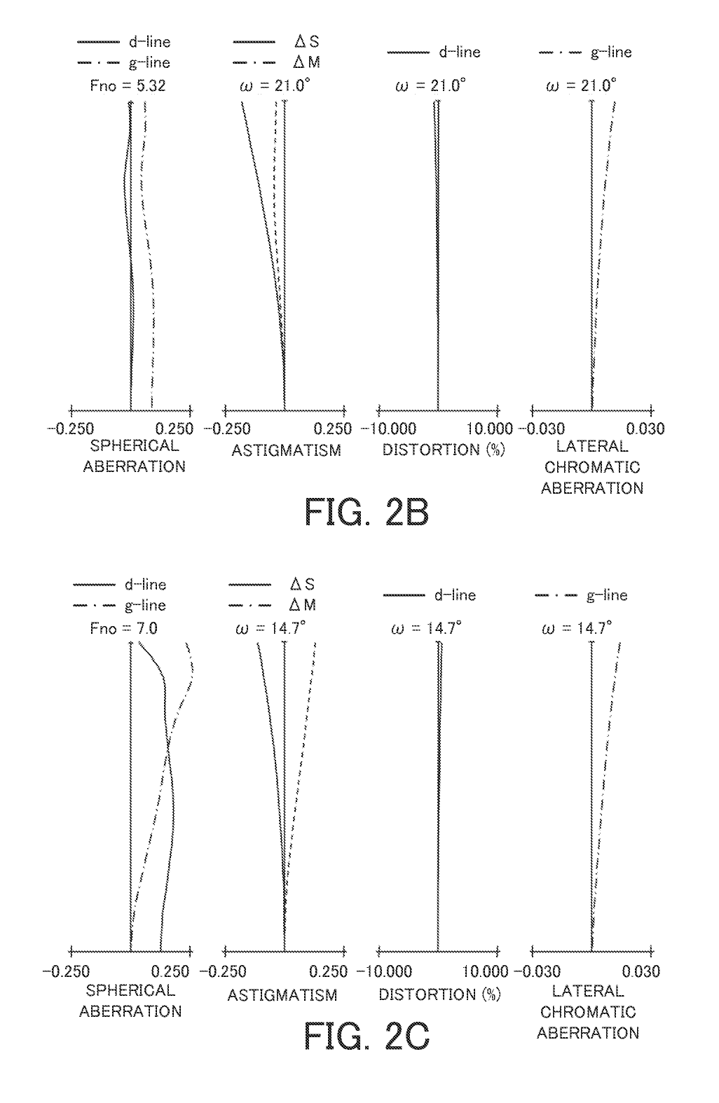

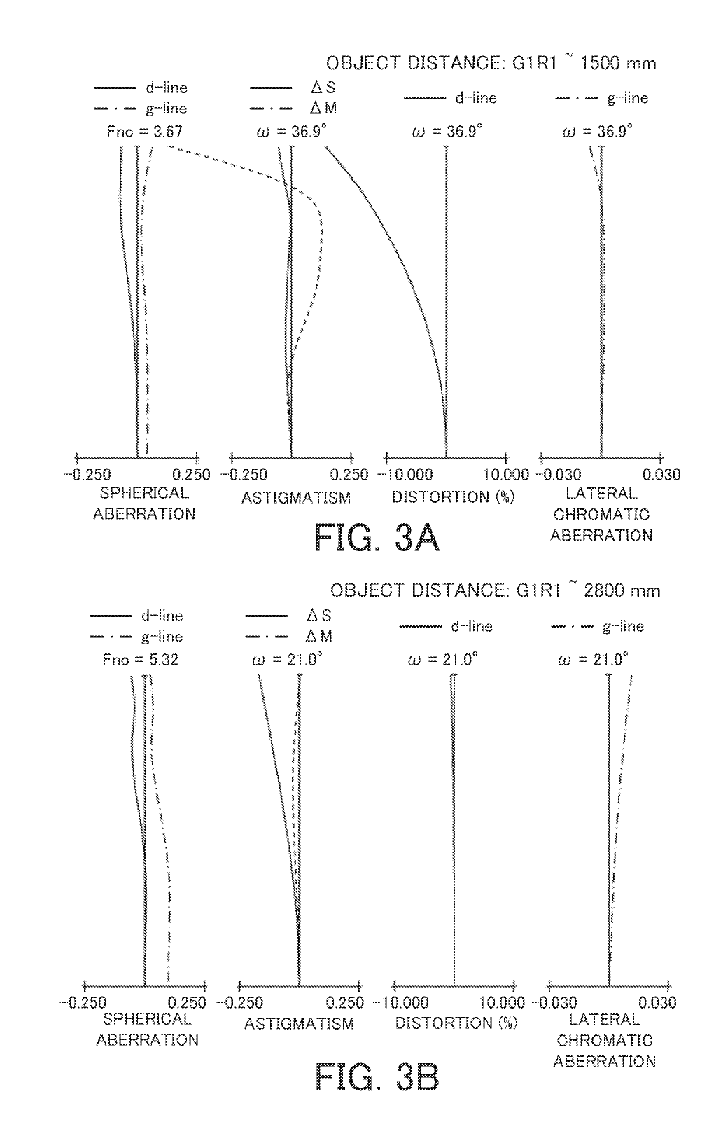

FIG. 1 is a lens sectional view at a wide-angle end (short focal length end) of the zoom lens according to the first embodiment of the present invention. FIGS. 2A, 2B, and 2C are longitudinal aberrational diagrams at the wide-angle end, an intermediate zoom position, and a telephoto end when an infinite object is brought into an in-focus according to the first embodiment. FIGS. 3A, 3B, and 3C are longitudinal aberrational diagrams at the wide-angle end, the intermediate zoom position, and the telephoto end when a finitely distant object is brought into an in-focus according to the first embodiment.

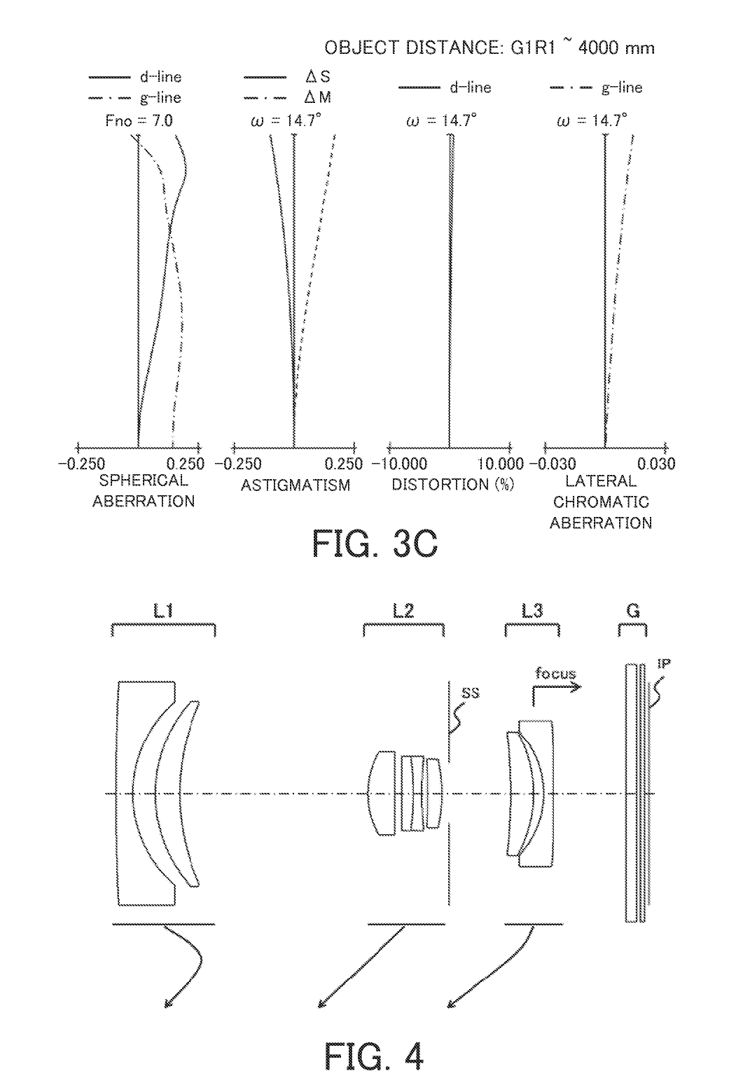

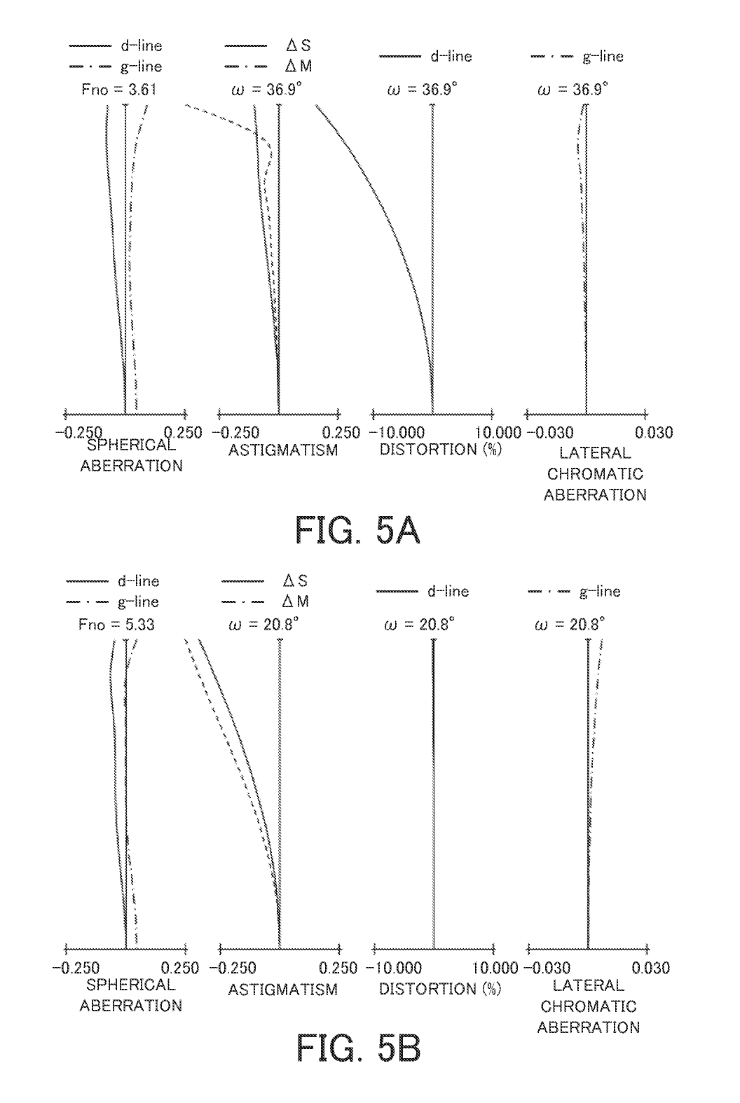

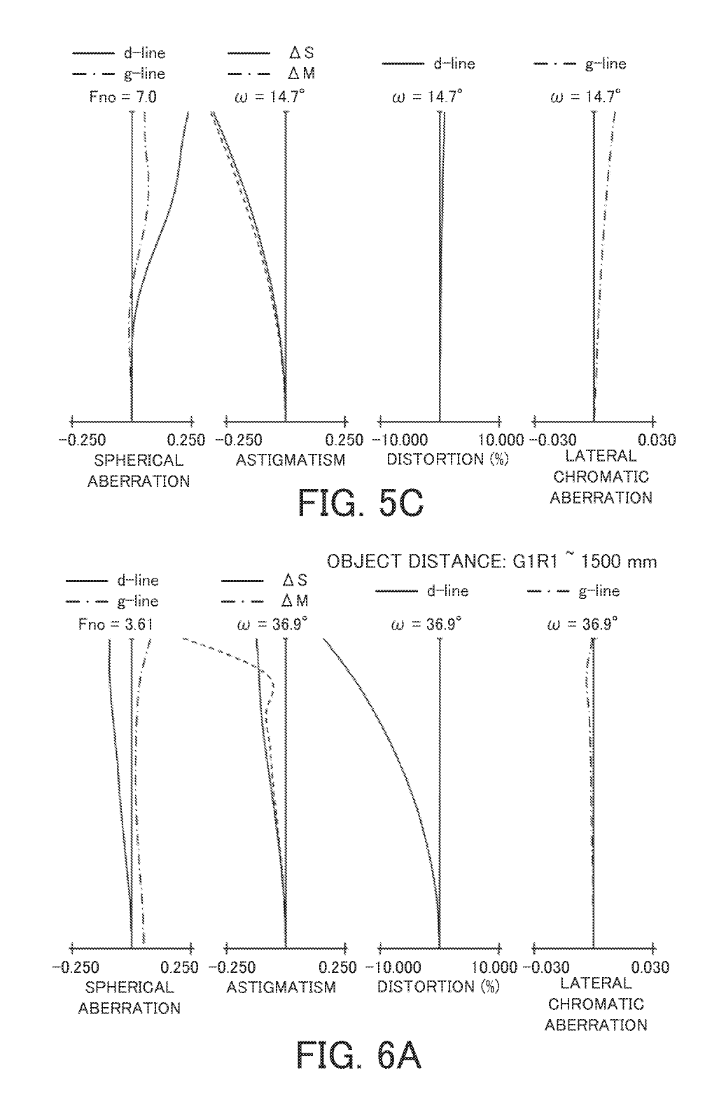

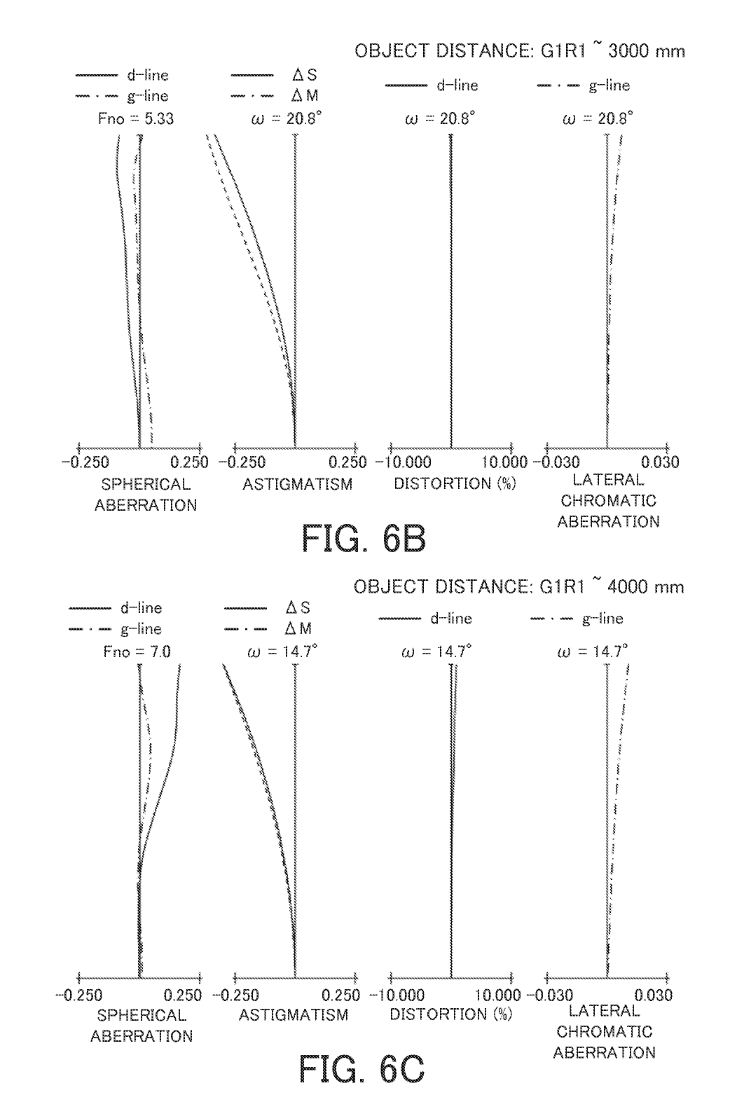

FIG. 4 is a lens sectional view at a wide-angle end according to the second embodiment. FIGS. 5A, 5B, and 5C are longitudinal aberrational diagrams at the wide-angle end, an intermediate zoom position, and a telephoto end when an infinite object is brought into an in-focus according to the second embodiment. FIGS. 6A, 6B, and 6C are longitudinal aberrational diagrams at the wide-angle end, the intermediate zoom position, and the telephoto end when a finitely distant object is brought into an in-focus according to the second embodiment.

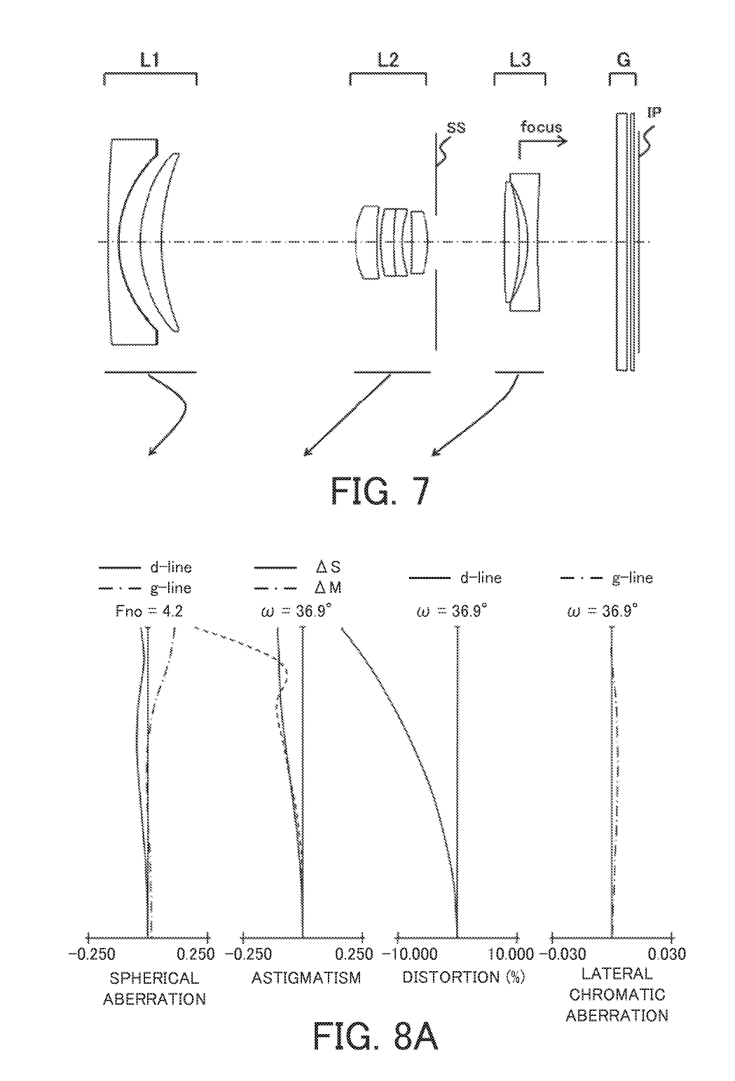

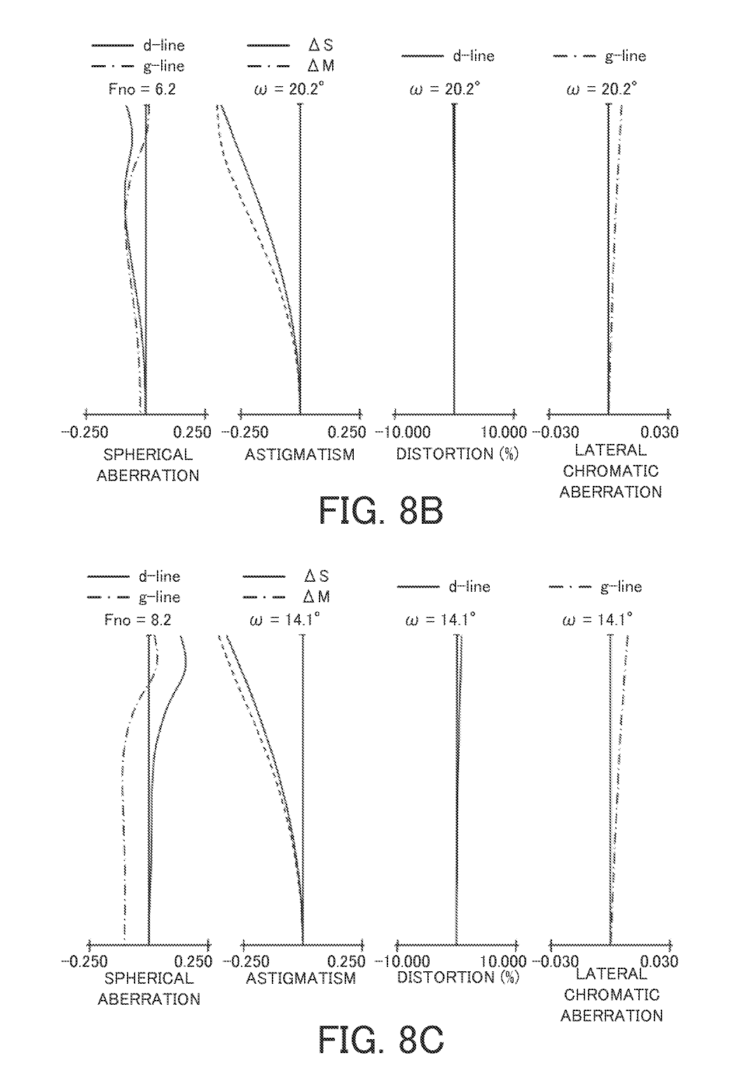

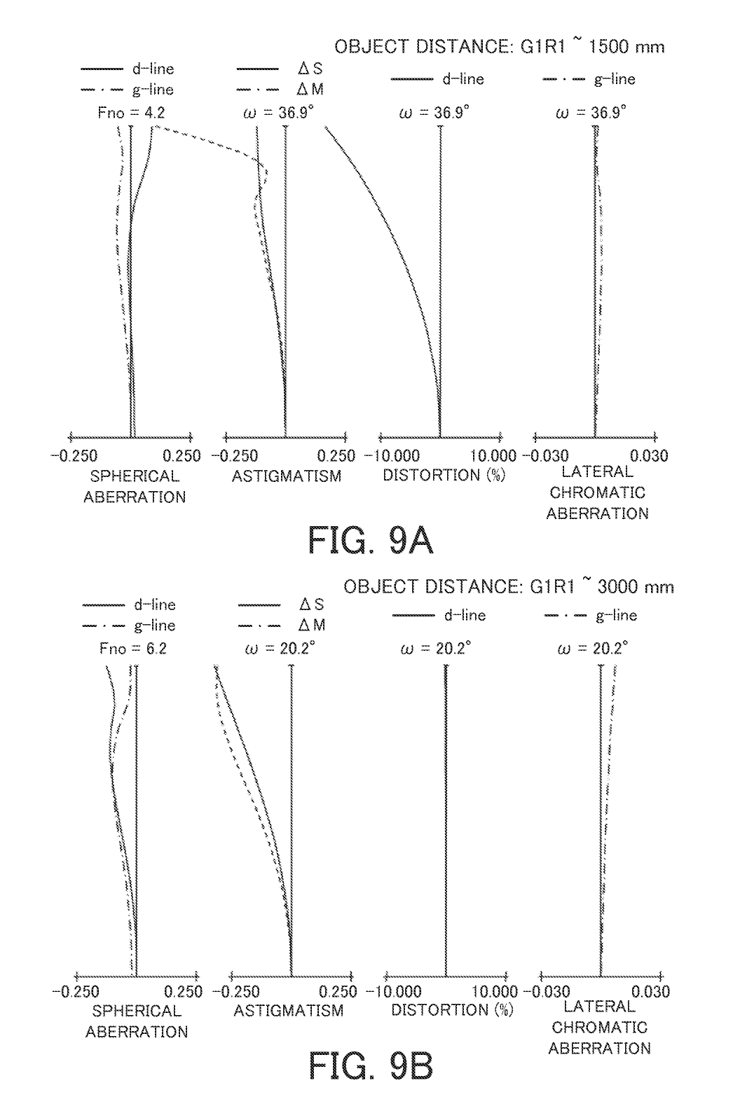

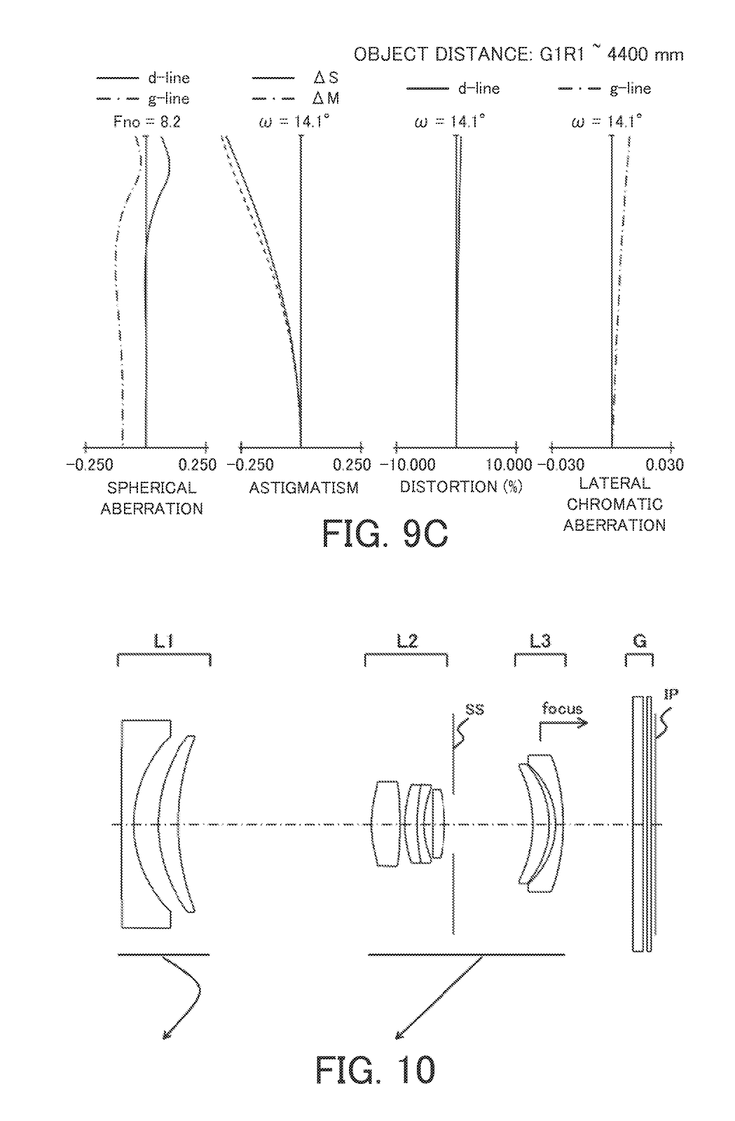

FIG. 7 is a lens sectional view at a wide-angle end according to the third embodiment. FIGS. 8A, 8B, and 8C are longitudinal aberrational diagrams at the wide-angle end, an intermediate zoom position, and a telephoto end when an infinite object is brought into an in-focus according to the third embodiment. FIGS. 9A, 9B, and 9C are longitudinal aberrational diagrams at the wide-angle end, the intermediate zoom position, and the telephoto end when a finitely distant object is brought into an in-focus according to the third embodiment.

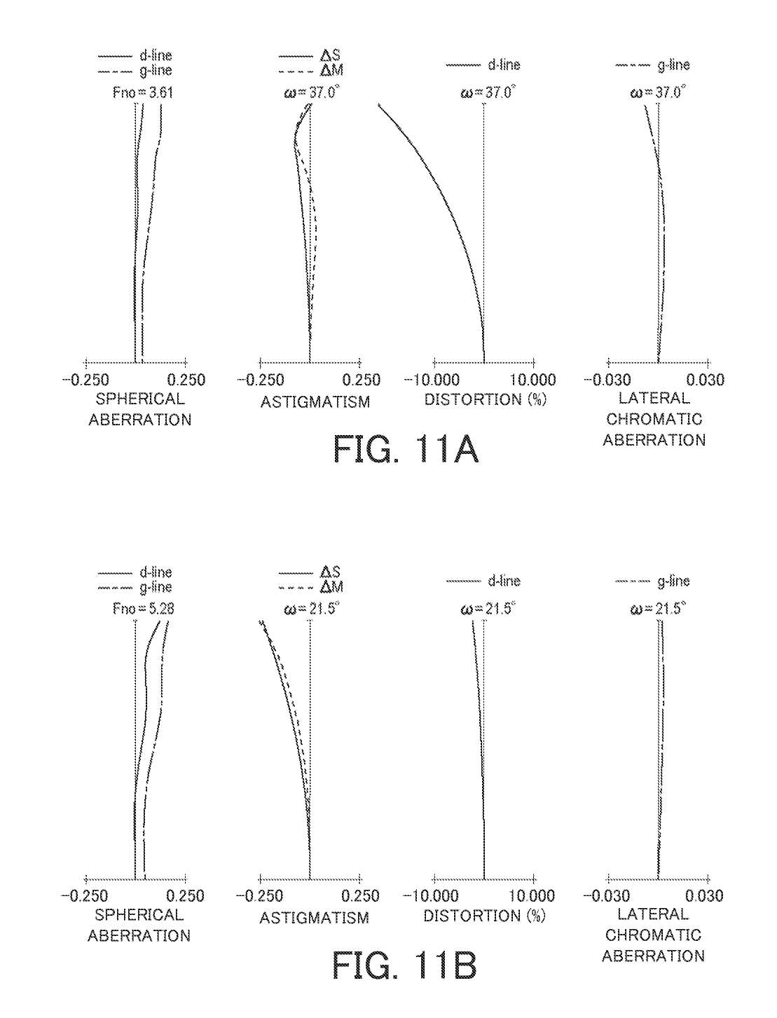

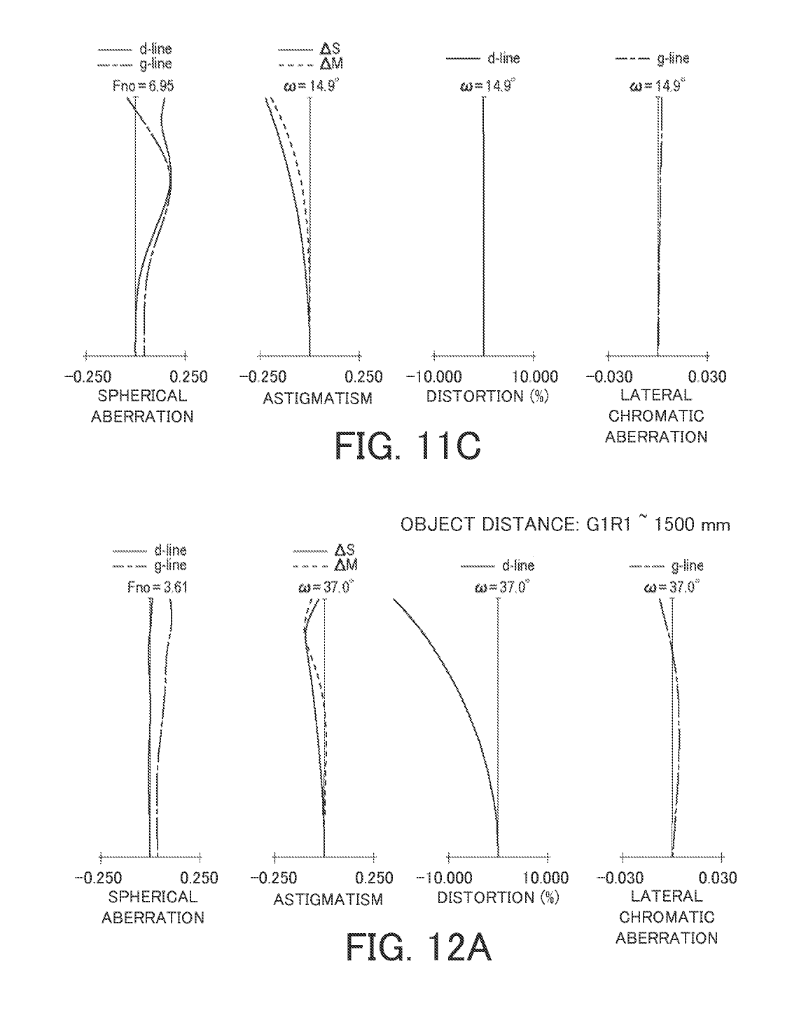

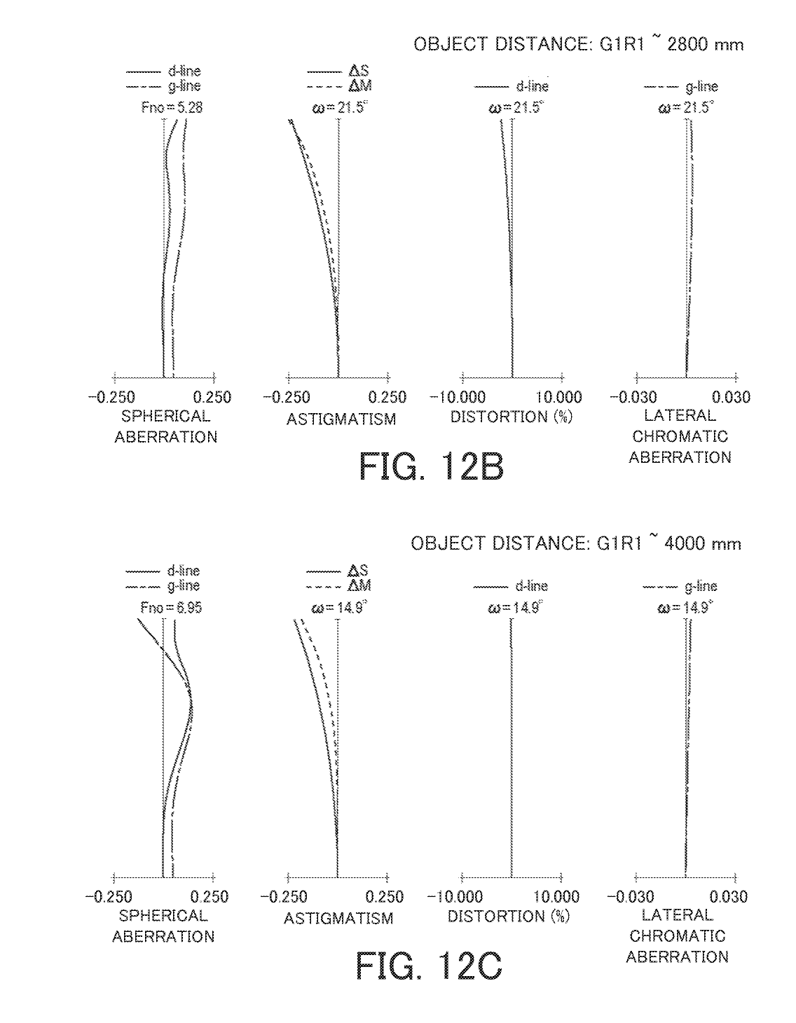

FIG. 10 is a lens sectional view at a wide-angle end according to the fourth embodiment. FIGS. 11A, 11B, and 11C are longitudinal aberrational diagrams at a wide-angle end, an intermediate zoom position, and a telephoto end when an infinite object is brought into an in-focus according to the fourth embodiment. FIGS. 12A, 12B, and 12C are longitudinal aberrational diagrams at a wide-angle end, an intermediate zoom position, and a telephoto end when a finitely distant object is brought into an in-focus according to the fourth embodiment.

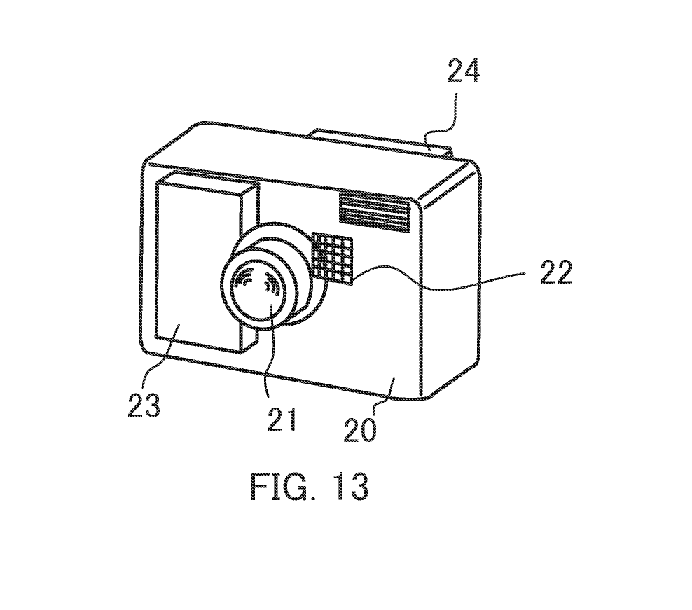

FIG. 13 is a schematic view of a principal part of an image pickup apparatus according to the present invention.

The first to fourth embodiments correspond to numerical examples 1 to 4. In each lens sectional view, L1 denotes a first lens unit having a negative refractive power, L2 denotes a second lens unit having a positive refractive power, and L3 denotes a third lens unit having a negative refractive power. In each lens sectional view, a left side is an object side (front side), and a right side is an image side (backside). The first lens unit L1, the second lens unit L2, and the third lens unit L3 are arranged from the object side to the image side in this order.

SS denotes an aperture diaphragm (aperture stop). G denotes an optical block provided in the design on the assumption of an optical filter and a face plate of an image sensor. IP denotes an image plane corresponding to an image pickup plane of a solid state image sensor (photoelectric conversion element), such as a CCD sensor and a CMOS sensor.

An arrow denotes a moving locus of each lens during zooming from the wide-angle end to the telephoto end. In the longitudinal aberration diagram, d-line denotes the d-line, g-line denotes the g-line, ΔM denotes a meridional image plane, and ΔS denotes a sagittal image plane. The lateral chromatic aberration is expressed by the g-line, ω denotes half an image pickup angle of view, and Fno denotes an F number.

The zoom lens according to the present invention includes, in order from an object side to an image side, the first lens unit L1 having the negative refractive power, the second lens unit L2 having the positive refractive power, and the third lens unit L3 having the negative refractive power. A distance between two adjacent lens units varies in at least one of zooming and focusing. The zoom lens according to the present invention is a negative lead type zoom lens that includes a front lens unit having a negative refractive power, maintains a wide angle of view, and facilitates a compact configuration of the overall system. In addition, the present invention adopts a telephoto type arrangement in which the second lens unit L2 and the third lens unit L3 are set to lens units having positive and negative refractive powers for a compact configuration of the lens overall length (a distance from the first lens surface to the image plane).

The present invention also adopts a rear focus system in which the third focus lens unit L3 is moved to the image side in focusing from an infinite object to the finite distant object. This configuration enables the lightweight third lens unit L3 that has a small outer diameter to be set to the focus lens unit, and facilitates fast focusing.

Each of the first lens unit L1 to the third lens unit L3 has at least one positive lens and at least one negative lens. This configuration corrects monochromatic aberration and lateral chromatic aberration of each lens unit, and can obtain good optical performance in the overall zoom range. In addition, the zoom lens of each embodiment satisfies all of the following conditional expressions where f1 is a focal length of the first lens unit, f3 is a focal length of the third lens unit, skw is a back focus at a wide-angle end (which is converted into an airy value in a glass block), and fw is a focal length of an entire system at the wide-angle end:

0.7<f1/f3<1.2 (1)

2.5<|f3|/skw<6.0 (2)

1.5<|f1|/fw<2.40 (3)

The conditional expression (1) defines the balance of the refractive power between the first lens unit L1 and the third lens unit L3. The zoom lens according to the present invention optimizes the refractive powers of the first lens unit L1 and the third lens unit L3, and sets a compact configuration of the overall system and the exit pupil position in a well-balanced manner.

When the value is smaller than the lower limit of the conditional expression (1), the focal length of the first lens unit L1 becomes too short for the third lens unit L3. Then, the telephoto type causes a weak refractive power arrangement of the overall system at the wide-angle end, enlarging the back focus and the overall lens length. On the other hand, when the value is larger than the upper limit, the focal length of the first lens unit L1 is too long for the third lens unit L3.

Then, the telephoto type causes an extremely strong refractive power arrangement of the overall system at the wide-angle end, and the exit pupil position is too close to the image plane. In this case, the (obliquely) incident angle of the ray upon the electronic image sensor (solid state image sensor) is too large, sensor shading occurs even when the technology, such as the optimization of the on-chip micro lens is applied, and the correction becomes difficult.

The conditional expression (2) defines a ratio between the focal length of the third lens unit L3 and the back focus at the wide-angle end. The rear focus is promoted by properly setting the ratio between the focal length of the third lens unit L3 and the back focus at the wide angle. When the value is smaller than the lower limit of the conditional expression (2), the focal length of the third lens unit L3 is too short and it becomes difficult to satisfy the conditional expression (1). Then, the telephoto type causes a refractive power arrangement of the overall system to be strong at the wide-angle end, and the exit pupil position is too close to the image plane.

On the other hand, when the value is larger than the upper limit, the focal length of the third lens unit L3 becomes too long, and it is difficult to provide a refractive power arrangement suitable for the rear focus or the back focus at the wide-angle end becomes too short to easily secure a moving space of the focus lens unit.

The conditional expression (3) defines the focal length of the first lens unit L1. The compact overall system and the good optical performance can be obtained by properly setting the focal length of the first lens unit L1. When the value is smaller than lower limit of the conditional expression (3), the absolute value of the focal length of the first lens unit L1 becomes too low and it is difficult to correct the curvature of field and astigmatism at the wide-angle end. When the value is larger than the upper limit, the focal length of the first lens unit L1 becomes too long, the front effective diameter increases and it is difficult to satisfy the conditional expression (1). As a result, the telephoto type causes the refractive power arrangement to be strong at the wide-angle end, and the exit pupil position is excessively close to the image plane.

As described above, each embodiment arranges the lens units having negative, positive, and negative refractive powers and satisfies all of the conditional expressions (1) to (3). This configuration reduces a size of an overall system, and realizes a rear focus type zoom lens suitable for an electronic image sensor that allows an oblique incidence of the light flux, and applicable to a large image sensor.

Each embodiment may set the numerical ranges of the conditional expressions (1) to (3) as follows:

0.72<f1/f3<1.10 (1a)

3.0<|f3|/skw<5.6 (2a)

1.6<|f1|/fw<2.2 (3a)

Each embodiment may set the numerical ranges of the conditional expressions (1a) to (3a) as follows:

0.74<f1/f3<1.00 (1b)

3.5<|f3|/skw<5.2 (2b)

1.7<|f1|/fw<2.0 (3b)

Next follows a description of a structure of each embodiment. In each embodiment, R1nr is a radius of curvature of a lens surface on an image side of a negative lens having the largest absolute value of a negative refractive power in the first lens unit L1, and R1nf is a radius of curvature of a lens surface on an object side of the negative lens that has the largest absolute value of the negative refractive power in the first lens unit L1.

D1 is a distance on an optical axis between a lens surface closest to an object in the first lens unit L1 and a lens surface closest to an image in the first lens unit L1, f2 is a focal length of the second lens unit L2, and D23w is a distance on the optical axis between the lens surface closest to the image in the second lens unit L2 and the lens surface closest to the object in the third lens unit L3 at the wide-angle end. X2 is a moving amount of the second lens unit L2 during zooming from the wide-angle end to the telephoto end when the infinite object is brought into an in-focus. X3 is a moving amount of the third lens unit L3 during zooming from the wide-angle end to the telephoto end when the infinite object is brought into an in-focus.

In addition, β2w is a lateral magnification of the second lens unit L2 when the infinite object is brought into an in-focus at the wide-angle end, and β2t is a lateral magnification of the second lens unit L2 when the infinite object is brought into an in-focus at the telephoto end. β3w is a lateral magnification of the third lens unit L3 when the infinite object is brought into an in-focus at the wide-angle end, and β3t is a lateral magnification of the third lens unit L3 when the infinite object is brought into an in-focus at the telephoto end.

At this time, one or more of the following conditional expressions may be satisfied:

−1.8<(R1nr+R1nf)/(R1nr−R1nf)<−0.8 (4)

0.1<D1/fw<0.8 (5)

1.5<f2/D23w<3.0 (6)

0.70<|X2|/fw<2.00 (7)

0.6<X2/X3<1.5 (8)

1.45<|f1|/f2<3.00 (9)

1.0<(β2t*β3w)/(β2w*β3t)<2.0 (10)

The moving amount during zooming from the wide-angle end to the telephoto end means a difference in an optical axis direction between a position at the wide-angle end and a position at the telephoto end. A sign of the moving amount is positive when the zoom lens moves to the image side at the telephoto end in comparison with the wide-angle end, and negative when the zoom lens moves to the object side.

When the zoom lens of each embodiment is used for an image pickup apparatus that includes an image sensor configured to receive light of an image formed by the zoom lens, Yim is half a diagonal length of an effective image pickup plane of the image sensor. At this time, the following conditional expression may be satisfied:

1.0<f2/Yim<2.0 (11)

A description will now be given of a technical meaning of each conditional expression.

The conditional expression (4) defines the lens shape of the negative lens that has the largest absolute value of the negative refractive power in the first lens unit L1. Assume that when the negative lens having the largest absolute value of the negative refractive power in the first lens unit L1 is a complex aspheric lens or a cemented lens, each of a radius of curvature of the lens surface on the object side and a radius of curvature of the lens surface on the image side is a radius of curvature of an air contacting surface of the negative lens.

Each embodiment sets a negative meniscus shape with a convex facing the object side to the negative lens having the largest absolute value of the negative refractive power in the first lens unit.

In the conventional three-unit zoom lens that includes lens units having negative, positive, and negative refractive powers, a negative distortion is unlikely to occur at the wide-angle end due to the symmetry and the telephoto type arrangement in which the refractive arrangement is strong at the wide-angle end.

In the refractive power arrangement of the first lens unit L1 and the third lens unit L3 defined by the conditional expression (1) in each embodiment, the shape of the negative lens that has the largest absolute value of the negative refractive power in the first lens unit L1 satisfies the conditional expression (4), and the negative distortion is intentionally generated. In the image pickup apparatus that uses the electronic image sensor, a well-known method may be used to electronically correct the distortion of the optical system for the following effects. When the negative distortion is increased at the wide-angle end, a light flux having an angle of view wider than that found by the paraxial calculation forms an image on the sensor (electronic image sensor). At this time, on the assumption that the distortion is electronically corrected by the post processing, the maximum image height at the wide-angle end can be set to the maximum image height of the image sensor.

In other words, the zoom lens may be designed with a smaller image circle diameter at the wide-angle end, and a front effective diameter may be reduced at the wide-angle end determined by the maximum angle of view ray. In the three-unit zoom lens including the negative, positive, and negative refractive powers for use with the electronic image sensor, the negative distortion is large at the wide-angle end, and the overall system can be compact by electrically correcting the remaining distortion.

When the value is smaller than the lower limit of the conditional expression (4), the radius of curvature of the lens surface on the object side of the negative lens that has the largest absolute value of the negative refractive power in the first lens unit L1 is too small, the convex shape on the object side is too small, and an amount of the negative distortion reduces. When the value is larger than the upper limit, the radius of curvature of the lens surface on the object side of the negative lens that has the largest absolute value of the negative refractive power in the first lens unit L1 is too small, the convex shape on the image side is too small, and it becomes difficult to correct the astigmatism in the overall zoom range.

The conditional expression (5) defines the thickness of the first lens unit L1. The compact overall system and high performance are obtained by the properly set thickness of the first lens unit L1. When the value is smaller than the lower limit of the conditional expression (5), the first lens unit L1 becomes too thin, a shape of the airy lens in the first lens unit L1 becomes particularly restricted and it is difficult to correct the astigmatism in the overall zoom range. When the value is larger than the upper limit, the first lens unit becomes too thick, the front effective diameter increases, the camera thickness increases at the lens unit is retracted.

The conditional expression (6) defines a ratio of the distance at the wide-angle end between the second lens unit L2 and the third lens unit L3, to the focal length of the second lens unit L2. The miniaturization and optical performance of the image pickup apparatus and a high zoom ratio can be obtained by the properly set refractive power of the second lens unit L2.

When the value is smaller than the lower limit of the conditional expression (6), the focal length of the second lens unit L2 becomes too short, aberrational fluctuations, such as fluctuations of the spherical aberration and coma, increase, and their corrections become difficult. When the value is larger than the upper limit, the focal length of the second lens unit L2 is too long, a moving amount of the second lens unit L2 increases due to a high zoom ratio, and the optical system becomes large.

Alternatively, the distance between the second lens unit L2 and the third lens unit L3 becomes too short at the wide angle, and the optical arrangement of the telephoto type that includes the second lens unit L2 and the third lens unit L3 is mitigated in the refractive power arrangement that satisfies the conditional expressions (1) to (3). Thereby, the back focus and the overall length of the optical system increase.

The conditional expression (7) defines a moving amount of the second lens unit L2 during zooming from the wide-angle end to the telephoto end. Each embodiment optimizes the moving amount of the second lens unit L2, and maintains a wide angle of view, a high zoom ratio, and a compact overall system.

When the value is smaller than the lower limit of the conditional expression (7), the moving amount of the second lens unit L2 becomes too short, and it is necessary to extremely increase the refractive power of the second lens unit L2 for the high zoom ratio. As a result, it is difficult to correct aberrational fluctuations, such as fluctuations of the spherical aberration and coma, in the entire zoom range. Alternately, it is necessary to increase a burden of the magnification variation of the third lens unit L3 and to intensify the refractive power of the third lens unit L3 more than the value determined by the conditional expression (1), and the exit pupil position becomes too close to the image plane.

When the value is larger than the upper limit, a moving amount of the second lens unit L2 becomes too long during zooming from the wide-angle end to the telephoto end, and the overall system becomes larger.

The conditional expression (8) defines a ratio of a moving amount between the second lens unit L2 and the third lens unit L3 during zooming. Both the second lens unit L2 and the third lens unit L3 move to the object side during zooming from the wide-angle end to the telephoto end so as to divide the magnification variation of the overall system and to reduce the back effective diameter.

When the value is lower than the lower limit of the conditional expression (8), a moving amount of the third lens unit L3 is too large for the second lens unit L2, and the third lens unit L3 having the negative refractive power becomes closer to the image at the wide-angle end. Then, in an attempt to satisfy the conditional expressions (1) and (2), the exit pupil position is excessively close to the image plane. When the value is larger than the upper limit, a moving amount of the third lens unit L3 is too small for a moving amount of the second lens unit L2, the third lens unit L3 becomes closer to the image side at the telephoto end, and the back effective diameter increases.

The conditional expression (9) defines a ratio between the focal length of the first lens unit L1 and the focal length of the second lens unit L2. A compact configuration of the overall system and the exit pupil position can be properly established by properly setting the focal lengths of the first lens unit L1 and the second lens unit L2. When the value is smaller than the lower limit of the conditional expression (9), the focal length of the first lens unit L1 is too short for the second lens unit L2, the telephoto type causes the refractive power arrangement of the entire system to be weak at the wide-angle end, and the overall system becomes larger.

When the value is larger than the upper limit, the focal length of the first lens unit L1 is too long for the second lens unit L2, the telephoto type causes the refractive arrangement of the overall system to be strong at the wide-angle end, and the exit pupil position is excessively close to the image plane.

The conditional expression (10) defines a magnification variation allotment between the second lens unit L2 and the third lens unit L3. The high zoom ratio and the exit pupil position can be properly established by the properly set magnification variation allotment between the second lens unit L2 and the third lens unit L3. The value smaller than the lower limit of the conditional expression (10) causes a refractive power arrangement in which the magnification variation burden of the third lens unit L3 is larger during zooming from the wide-angle end to the telephoto end, and it is necessary to make the refractive power of the third lens unit L3 higher than the value defined in the conditional expression (1). Hence, the exit pupil position is excessively close to the image plane.

The value larger than the upper limit causes a refractive power arrangement in which the magnification variation burden of the second lens unit L2 is larger during zooming from the wide-angle end to the telephoto end. As a result, the refractive power of the second lens unit L2 becomes too strong, and it becomes difficult to correct aberrational fluctuations, such as fluctuations of the spherical aberration and coma, during zooming from the wide-angle end to the telephoto end. Alternatively, a moving amount of the second lens unit L2 becomes large during zooming, and the overall system becomes large.

Each embodiment may set the numerical ranges of the conditional expressions (4) to (10) as follows:

−1.6<(R1nr+R1nf)/(R1nr−R1nf)<−0.9 (4a)

0.2<D1/fw<0.65 (5a)

1.6<f2/D23w<2.8 (6a)

0.8<|X2|/fw<1.7 (7a)

0.75<X2/X3<1.2 (8a)

1.6<|f1|/f2<2.5 (9a)

1.1<(β2t*β3w)/(β2w*β3t)<1.8 (10a)

Each embodiment may set the numerical ranges of the conditional expressions (4a) to (10a) as follows:

−1.4<(R1nr+R1nf)/(R1nr−R1nf)<−1.0 (4b)

0.3<D1/fw<0.5 (5b)

1.7<f2/D23w<2.6 (6b)

0.9<|X2|/fw<1.4 (7b)

0.9<X2/X3<1.1 (8b)

1.7<|f1|/f2<2.0 (9b)

1.2<(β2t*β3w)/(β2w*β3t)<1.6 (10b)

The conditional expression (11) defines a ratio between the focal length of the second lens unit L2 and half a diagonal length of the image plane of the image pickup apparatus. The compact image pickup apparatus and the high magnification variation ratio with the maintained performance can be acquired by the properly set refractive power of the second lens unit L2.

When the value is smaller than the lower limit of the conditional expression (11), the focal length of the second lens unit L2 becomes too short and it becomes difficult to correct aberrational fluctuations, such as fluctuations of the spherical aberration and coma, during zooming from the wide-angle end to the telephoto end.

When the value is larger than the upper limit, the focal length of the second lens unit L2 becomes too long, a moving amount of the second lens unit L2 increases due to the high zoom ratio, and the image pickup apparatus becomes larger.

The numerical range of the conditional expression (11) may be set as follows:

1.1<f2/Yim<1.7 (11a)

The numerical range of the conditional expression (11a) may be set as follows:

1.2<f2/Yim<1.5 (11b)

Each embodiment moves the third lens unit L3 to the object side during zooming from the wide-angle end to the telephoto end. Thereby, the magnification variation is allotted by the third lens unit L3, and the back effective diameter is reduced.

In the first to third embodiments, the second lens unit L2 and the third lens unit L3 are configured to independently move in the magnification variation. Due to the degree of freedom of the position of the third lens unit, in particular, fluctuations of the curvature of field can be well corrected in the magnification-varying intermediate range.

The fourth embodiment moves the second lens unit L2 and the third lens unit L3 together in the magnification variation. When these two units configured to move as one combined unit are set to a back unit so as to provide a telephoto type arrangement in which the positive front partial unit L2 and the negative back partial unit L3 are arranged in the back unit in this order, the overall length of the optical system can be reduced. This configuration move the second lens unit L2 and the third lens unit L3 as the focus unit together, simplifies the barrel structure of the optical system, and makes small the lens including the barrel.

As discussed, each embodiment reduces a size of the zoom lens compatible with a large sensor, and provides a rear focus type zoom lens that is suitable for an electronic image sensor and allows the oblique incidence.

### First Embodiment

Referring now to FIG. 1, a description will be given of a zoom lens according to the first embodiment of the present invention. The first embodiment illustrated in FIG. 1 provides a three-unit zoom lens including lens units having negative, positive, and negative refractive powers in order from the object side to the image side.

In the first embodiment illustrated in FIG. 1, during zooming from the wide-angle end to the telephoto end, the first lens unit L1 and the second lens unit L2 move so that the distance between them is shorter. Herein, the second lens unit L2 and the third lens unit L3 are magnification varying lens units configured to move to the object side and to bear a burden of the magnification variation. The first lens unit L1 moves with a convex locus on the image side and corrects the image plane fluctuation associated with the zooming.

The aperture diaphragm SS is arranged on the object side of the second lens unit L2, and moves with (the same locus as that of) the second lens unit L2 during zooming. The second lens unit L2 as the main magnification varying lens has a four-unit structure including, in order from the object side to the image side, a positive lens, a positive lens, a negative lens, and a positive lens.

The aberrational fluctuation during zooming is well corrected by making the magnification varying lens unit a highly symmetrical lens so as to correct the asymmetrical aberration in the lens unit. For focusing from the infinite object to finitely distant object, there is a rear focus system configured to move the third lens unit L3 to the image side. The lightweight third lens unit L3 that has a small effective diameter is set to the focus lens unit so as to facilitate fast focusing. The third lens unit L3 includes, in order from the object side, a positive lens, an airy lens, and a negative lens. The effective diameter of the third lens unit L3 is reduced by arranging the negative lens closest to the image in the third lens unit L3. The degree of freedom of the aberrational correction in the third lens unit L3 is secured by arranging the airy lens having the negative refractive power between the positive lens and the negative lens in the third lens unit, and the focus fluctuation of the spherical aberration is well corrected.

### Second Embodiment

Referring now to FIG. 4, a description will be given of a zoom lens according to the second embodiment of the present invention. A zooming type and a focusing method of the zoom lens according to the second embodiment illustrated in FIG. 4 are the same as those of the first embodiment illustrated in FIG. 1. The second embodiment is different from the first embodiment in the position of the aperture diaphragm SS and the lens structure of the second lens unit.

The aperture diaphragm SS is arranged on the image side of the second lens unit L2, and moves with the second lens unit L2 during zooming. The diaphragm diameter is reduced and the effective diameters of the second lens unit L2 and the third lens unit L3 are reduced by arranging the aperture diaphragm SS on the image side of the second lens unit L2. The second lens unit L2 has a four-unit structure including, in order from the object side to the image side, a positive lens, a cemented lens made by joining a positive lens with a negative lens, and a positive lens. The aberration fluctuation is well corrected during zooming by making symmetric the lens structure of the second lens unit L2 as the main magnification varying lens unit.

### Third Embodiment

Referring now to FIG. 7, a description will be given of a zoom lens according to the third embodiment of the present invention. A zooming type, a diaphragm position, a focusing method, etc. of the zoom lens according to the third embodiment illustrated in FIG. 7 are the same as those of the second embodiment illustrated in FIG. 4. The third embodiment is different from the second embodiment in the lens structure of the first lens unit L1. The first lens unit L1 has two lens components including, in order from the object side to the image side, a complex aspheric lens that joins an aspheric component G12 made of resin with a spherical lens G11 having a negative refractive power, and a positive lens G13.

### Fourth Embodiment

Referring now to FIG. 10, a description will be given of a zoom lens according to the fourth embodiment of the present invention. The fourth embodiment illustrated in FIG. 10 provides a two-unit zoom lens including lens units having negative and positive refractive powers in order from the object side to the image side.

In the fourth embodiment illustrated in FIG. 10, the first lens unit L1 and the second lens unit L2 move so that the their distance reduces during zooming from the wide-angle end to the telephoto end. The second lens unit L2 and the third lens unit L3 move together to the image side during zooming. The second lens unit L2 and the third lens unit L3 correspond to part of a lens unit having a positive refractive power arranged on the image side of the two-unit zooming. The first lens unit L1 moves with a convex locus on the image side and corrects the image plane fluctuation associated with the zooming.

The aperture diaphragm SS is arranged between the second lens unit L2 and the third lens unit L3.

The structures of the second lens unit L2 and the third lens unit L3 and a focusing method are the same as those of the first embodiment illustrated in FIG. 1, and the effect of each lens unit is equivalent.

The fourth embodiment enables the second lens unit and the third lens unit to move together, simplifies the barrel structure, and makes small the overall lens system containing the barrel.

As described above, the zoom lens in each embodiment includes, in order from the object side to the image side, three lens units having negative, positive, and negative refractive powers. During zooming from the wide-angle end to the telephoto end, the first lens unit L1 and the second lens unit L2 move so that the distance between them reduces. The aperture diaphragm SS is arranged near the second lens unit L2. Each lens unit includes a positive lens and a negative lens at least one each.

Each embodiment provides the lens structure and the refractive power arrangement such that all of the conditional expressions (1) to (3) are satisfied. This configuration realizes a rear focus type zoom lens having a good optical performance and a compact overall system, optimizes an oblique incident angle of a light flux upon an image plane for an electronic image sensor that permits an oblique incidence upon the image sensor.

The entire second lens unit L2 may be moved in a direction having a component perpendicular to the optical axis for image stabilizations.

While the present invention has been described with reference to exemplary embodiments, it is to be understood that the invention is not limited to the disclosed exemplary embodiments. For example, in order to handle with fluctuations of the F-number during zooming in the zoom lens of each embodiment, control of changing an aperture diaphragm diameter according to the zoom position may be provided. In addition, the distortion remaining in the zoom lens may be electronically corrected by a well-known approach (such as image processing).

Referring to FIG. 13, a description will be given of an embodiment in which a digital still camera is illustratively used for an image pickup apparatus according to the present invention. In FIG. 13, reference numeral 20 denotes a camera body, and reference numeral 21 denotes an image pickup optical system that includes the zoom lens according to the present invention. Reference numeral 22 denotes a solid state image sensor (photoelectric conversion element), such as a CCD sensor and a CMOS sensor, configured to receive an object image formed by the image pickup optical system 21.

Reference numeral 23 denotes a memory configured to record information corresponding to an object image photoelectrically converted by the image sensor 22. Reference numeral 24 denotes a finder including a liquid crystal display panel, and configured to observe the object image formed by the solid state image sensor 22. Thus, the present invention provides a small image pickup optical system having a high optical performance.

Next follows numerical examples of the present invention. In each numerical example, “i” denotes a surface order from the object side, and “ri” denotes a radius of curvature of a lens surface. “di” denotes a lens thickness and an airy distance between an i-th surface and an (i+1)-th surface. “ndi” and “vdi” denote a refractive index and an Abbe number of the d-line. “%*” denotes an aspheric surface. Four surfaces closest to the image are made of glass material, such as a face plate. In addition, k, A4, A6, A8, and A10 are aspheric coefficients.

The aspheric shape is expressed by a displacement x in the optical axis direction at a position of a height h from the optical axis on the basis of the surface vertex where R denotes a paraxial radius of curvature:

x=(h²/R)/[1+{1−(1+k)(h/R)²}^{1/2}]+A4·h⁴+A6·h⁶+A8·h⁸+A10·h¹⁰

A back focus BF is expressed by a distance from a final surface (glass block surface). Table 1 summarizes a relationship between each conditional expression and each numerical example.

### Numerical Example 1

Unit: mm
Surface data

| Surface | | | | | effective |
|---|---|---|---|---|---|
| No. | r | d | nd | νd | diameter |
| 1 | 387.771 | 2.00 | 1.85135 | 40.1 | 23.12 |
| 2* | 15.233 | 2.80 | | | 19.18 |
| 3 | 16.835 | 2.50 | 1.92286 | 20.9 | 19.07 |
| 4 | 26.188 | (variable) | | | 18.29 |
| 5 (diaphragm) | ∞ | 0.30 | | | 9.11 |
| 6* | 9.622 | 3.30 | 1.58313 | 59.4 | 9.50 |
| 7 | 34.395 | 0.40 | | | 8.74 |
| 8 | 17.167 | 1.90 | 1.60311 | 60.6 | 8.50 |
| 9 | 105.980 | 0.80 | | | 7.89 |
| 10 | −22.467 | 1.10 | 1.84666 | 23.8 | 7.63 |
| 11 | 54.827 | 0.80 | | | 7.41 |
| 12 | 54.827 | 1.70 | 1.55332 | 71.7 | 7.33 |
| 13* | −23.447 | (variable) | | | 7.23 |
| 14 | −27.978 | 2.00 | 1.80518 | 25.4 | 12.94 |
| 15 | −13.562 | 1.50 | | | 13.51 |
| 16 | −10.128 | 1.20 | 1.76802 | 49.2 | 13.63 |
| 17* | −49.739 | (variable) | | | 16.14 |
| 18 | ∞ | 1.20 | 1.54400 | 58.6 | 30.00 |
| 19 | ∞ | 0.50 | | | 30.00 |
| 20 | ∞ | 0.50 | 1.52300 | 58.6 | 30.00 |
| 21 | ∞ | | | | 30.00 |
| Image plane | ∞ | | | | |

Aspheric data
Second surface

| | | |
|---|---|---|
| K = −4.80469e−001 | A4 = 2.12585e−005 | A6 = 1.51789e−007 |
| A8 = −7.73775e−010 | A10 = 5.14417e−012 | |

Sixth surface

| | | |
|---|---|---|
| K = −6.58806e−001 | A4 = 1.05105e−004 | A6 = 1.75844e−006 |
| A8 = −7.89799e−009 | A10 = 6.29525e−010 | |

Thirteenth surface

| | | |
|---|---|---|
| K = 0.00000e+000 | A4 = 3.15140e−004 | A6 = 2.92427e−006 |
| A8 = 9.05200e−008 | | |

Seventeenth surface

| | | |
|---|---|---|
| K = 0.00000e+000 | A4 = −2.37683e−005 | A6 = −1.56665e−007 |
| A8 = 2.65842e−009 | A10 = −3.47758e−011 | |

Various data
Zoom ratio 2.86

| | Wide angle | intermediate | telephoto |
|---|---|---|---|
| Focal length | 18.10 | 35.51 | 51.80 |
| Fno | 3.67 | 5.32 | 7.00 |
| Half angle of | 36.92 | 20.96 | 14.71 |
| View (degree) | | | |
| Image height | 13.60 | 13.60 | 13.60 |
| Lens overall | 64.04 | 57.63 | 62.67 |
| Length | | | |
| BF | 0.50 | 0.50 | 0.50 |
| d4 | 22.95 | 6.53 | 1.55 |
| d13 | 7.09 | 7.00 | 6.26 |
| d17 | 9.00 | 19.10 | 29.86 |
| incident pupil position | 15.52 | 8.83 | 5.68 |
| exit pupil position | −23.08 | −33.15 | −43.56 |
| front principal | 19.72 | 6.86 | −3.42 |
| point position | | | |
| back principal | −17.60 | −35.01 | −51.30 |
| point position | | | |

zoom lens unit data

| | | | | front | back |
|---|---|---|---|---|---|
| | | | | principal | principal |
| | starting | focal | lens | point | point |
| unit | surface | length | length | position | position |
| L1 | 1 | −32.61 | 7.30 | 0.64 | −4.42 |
| L2 | 5 | 18.10 | 10.30 | 0.68 | −7.07 |
| L3 | 14 | −37.81 | 4.70 | 2.80 | −0.44 |
| G | 18 | ∞ | 2.20 | 0.80 | −0.80 |

Single lens data

| Lens | starting surface | focal length |
|---|---|---|
| 1 | 1 | −18.67 |
| 2 | 3 | 45.27 |
| 3 | 6 | 21.84 |
| 4 | 8 | 33.70 |
| 5 | 10 | −18.70 |
| 6 | 12 | 29.91 |
| 7 | 14 | 30.78 |
| 8 | 16 | −16.78 |
| 9 | 18 | 0.00 |
| 10 | 20 | 0.00 |

When a finitely distant object is brought into an in-
focus

| | Wide angle | intermediate | telephoto |
|---|---|---|---|
| Object distance | 1500 | 2800 | 4000 |
| Three-unit | 0.31 | 0.31 | 0.28 |
| moving amount | | | |

(assume that a movement to an image side is positive in focusing from infinite object to finite distant object)

### Numerical Example 2

Unit: mm
Surface data

| Surface | | | | | effective |
|---|---|---|---|---|---|
| No. | r | d | nd | νd | diameter |
| 1 | 291.593 | 2.00 | 1.85135 | 40.1 | 25.80 |
| 2* | 14.889 | 2.70 | | | 20.98 |
| 3 | 16.741 | 3.00 | 1.92286 | 20.9 | 21.22 |
| 4 | 26.592 | (variable) | | | 20.38 |
| 5* | 9.977 | 3.30 | 1.58313 | 59.4 | 9.33 |
| 6* | 1260.616 | 0.85 | | | 8.73 |
| 7 | −450.316 | 1.40 | 1.55332 | 71.7 | 8.38 |
| 8 | −36.744 | 1.00 | 1.80809 | 22.8 | 8.06 |
| 9 | 36.460 | 0.80 | | | 7.78 |
| 10 | −55.138 | 1.70 | 1.58313 | 59.4 | 7.70 |
| 11* | −14.722 | 0.80 | | | 7.67 |
| 12 (diaphragm) | ∞ | (variable) | | | 7.33 |
| 13 | −74.170 | 2.80 | 1.80518 | 25.4 | 13.40 |
| 14 | −15.425 | 1.20 | | | 14.03 |
| 15 | −11.054 | 1.20 | 1.81000 | 41.0 | 14.04 |
| 16* | −8868.834 | (variable) | | | 16.50 |
| 17 | ∞ | 1.20 | 1.51633 | 64.1 | 30.00 |
| 18 | ∞ | 0.50 | | | 30.00 |
| 19 | ∞ | 0.50 | 1.51633 | 64.1 | 30.00 |
| 20 | ∞ | | | | 30.00 |
| Image plane | ∞ | | | | |

Aspheric data
Second surface

| | | |
|---|---|---|
| K = 0.00000e+000 | A4 = 5.11287e−006 | A6 = 1.09011e−008 |
| A8 = −2.58759e−011 | A10 = −1.94223e−013 | |

Fifth surface

| | | |
|---|---|---|
| K = 0.00000e+000 | A4 = 1.43520e−005 | A6 = −7.93241e−007 |
| A8 = 6.92320e−009 | A10 = −1.36775e−009 | |

Sixth surface

| | | |
|---|---|---|
| K = 0.00000e+000 | A4 = 1.33329−e004 | A6 = −1.50021e−006 |
| A8 = −1.02383e−007 | | |

Eleventh surface

| | | |
|---|---|---|
| K = 0.00000e+000 | A4 = 1.30159e−004 | A6 = 2.66623e−006 |
| A8 = 8.06455e−008 | | |

Sixteenth surface

| | | |
|---|---|---|
| K = 0.00000e+000 | A4 = −3.34694e−005 | A6 = −3.77127e−008 |
| A8 = 2.01905e−009 | A10 = −2.95267e−011 | |

Various data
Zoom ratio 2.86

| | Wide angle | intermediate | telephoto |
|---|---|---|---|
| Focal length | 18.10 | 35.86 | 51.80 |
| Fno | 3.61 | 5.33 | 7.00 |
| Half angle of | 36.92 | 20.77 | 14.71 |
| View (degree) | | | |
| Image height | 13.60 | 13.60 | 13.60 |
| Lens overall | 64.57 | 57.36 | 62.54 |
| Length | | | |
| BF | 0.50 | 0.50 | 0.50 |
| d4 | 22.78 | 5.86 | 1.33 |
| d12 | 7.51 | 7.84 | 6.80 |
| d16 | 8.83 | 18.21 | 28.96 |
| incident pupil position | 18.64 | 13.89 | 12.07 |
| exit pupil position | −18.58 | −28.15 | −38.30 |
| front principal | 19.57 | 4.86 | −5.28 |
| point position | | | |
| back principal | −17.60 | −35.36 | −51.30 |
| point position | | | |

zoom lens unit data

| | | | | front | back |
|---|---|---|---|---|---|
| | | | | principal | principal |
| | starting | focal | lens | point | point |
| unit | surface | length | length | position | position |
| L1 | 1 | −33.05 | 7.70 | 0.89 | −4.26 |
| L2 | 5 | 18.25 | 9.85 | 1.38 | −6.43 |
| L3 | 13 | −35.11 | 5.20 | 3.97 | 0.52 |
| G | 17 | ∞ | 2.20 | 0.81 | −0.81 |

Single lens data

| Lens | starting surface | focal length |
|---|---|---|
| 1 | 1 | −18.49 |
| 2 | 3 | 42.73 |
| 3 | 5 | 17.23 |
| 4 | 7 | 72.22 |
| 5 | 8 | −22.51 |
| 6 | 10 | 33.92 |
| 7 | 13 | 23.68 |
| 8 | 15 | −13.66 |
| 9 | 17 | 0.00 |
| 10 | 19 | 0.00 |

When a finitely distant object is brought into an infocus

| | Wide angle | intermediate | telephoto |
|---|---|---|---|
| Object distance | 1500 | 3000 | 4000 |
| Three-unit | 0.32 | 0.32 | 0.27 |
| moving amount | | | |

(assume that a movement to an image side is positive in focusing from infinite object to finite distant object)

### Numerical Example 3

Unit: mm
Surface data

| Surface | | | | | effective |
|---|---|---|---|---|---|
| No. | r | d | nd | νd | diameter |
| 1 | 164.173 | 1.20 | 1.91082 | 35.3 | 24.04 |
| 2 | 14.642 | 0.10 | 1.51640 | 52.2 | 20.30 |
| 3* | 14.642 | 2.60 | | | 20.23 |
| 4 | 16.562 | 2.60 | 1.92286 | 18.9 | 20.52 |
| 5 | 27.749 | (variable) | | | 19.94 |
| 6* | 10.375 | 2.60 | 1.58313 | 59.4 | 8.13 |
| 7* | 40.106 | 0.50 | | | 7.66 |
| 8 | 18.038 | 1.60 | 1.49700 | 81.5 | 7.54 |
| 9 | 34.442 | 1.00 | 1.84666 | 23.8 | 7.17 |
| 10 | 12.673 | 1.14 | | | 6.85 |
| 11 | −80.517 | 2.00 | 1.55332 | 71.7 | 6.88 |
| 12* | −11.592 | 1.00 | | | 7.01 |
| 13 (diaphragm) | ∞ | (variable) | | | 6.65 |
| 14 | 190.308 | 1.80 | 1.80000 | 29.8 | 13.41 |
| 15 | −26.463 | 1.00 | | | 13.67 |
| 16 | −14.065 | 1.20 | 1.76802 | 49.2 | 13.69 |
| 17* | 81.718 | (variable) | | | 15.52 |
| 18 | ∞ | 1.20 | 1.51633 | 64.1 | 30.00 |
| 19 | ∞ | 0.50 | | | 30.00 |
| 20 | ∞ | 0.50 | 1.51633 | 64.1 | 30.00 |
| 21 | ∞ | | | | 30.00 |
| Image plane | ∞ | | | | |

Aspheric data
Third surface

| | | |
|---|---|---|
| K = 0.00000e+000 | A4 = 6.84186e−006 | A6 = −9.43341e−009 |
| A8 = 8.78082e−012 | A10 = −1.12196e−012 | |

Sixth surface

| | | |
|---|---|---|
| K = 0.00000e+000 | A4 = 4.52484e−005 | A6 = −1.26231e−007 |
| A8 = −4.70776e−008 | A10 = 1.30475e−009 | |

Seventh surface

| | |
|---|---|
| K = 0.00000e+000 | A4 = 2.82284e−004 |

Twelfth surface

| | | |
|---|---|---|
| K = 0.00000e+000 | A4 = −3.99118e−005 | A6 = 2.81379e−008 |
| A8 = −1.78639e−008 | | |

Seventeenth surface

| | | |
|---|---|---|
| K = 0.00000e+000 | A4 = −2.92220e−005 | A6 = −8.98012e−008 |
| A8 = 4.58425e−009 | A10 = −5.13498e−011 | |

Various data
Zoom ratio 3.00

| | Wide angle | intermediate | telephoto |
|---|---|---|---|
| Focal length | 18.10 | 37.01 | 54.30 |
| Fno | 4.20 | 6.20 | 8.20 |
| Half angle of | 36.92 | 20.17 | 14.06 |
| View (degree) | | | |
| Image height | 13.60 | 13.60 | 13.60 |
| Lens overall | 64.74 | 56.63 | 62.13 |
| Length | | | |
| BF | 0.50 | 0.50 | 0.50 |
| d5 | 23.65 | 5.27 | 0.50 |
| d13 | 8.38 | 9.53 | 8.78 |
| d17 | 9.67 | 18.79 | 29.80 |
| incident pupil position | 18.00 | 12.89 | 10.94 |
| exit pupil position | −19.44 | −29.19 | −39.80 |
| front principal | 19.67 | 3.77 | −7.93 |
| point position | | | |
| back principal | −17.60 | −36.51 | −53.80 |
| point position | | | |

zoom lens unit data

| | | | | front | back |
|---|---|---|---|---|---|
| | | | | principal | principal |
| | starting | focal | lens | point | point |
| unit | surface | length | length | position | position |
| L1 | 1 | −32.84 | 6.50 | 0.11 | −4.43 |
| L2 | 6 | 18.75 | 9.85 | 1.91 | −6.23 |
| L3 | 14 | −36.57 | 4.00 | 3.76 | 0.96 |
| G | 18 | ∞ | 2.20 | 0.81 | −0.81 |

Single lens data

| Lens | starting surface | focal length |
|---|---|---|
| 1 | 1 | −17.72 |
| 2 | 2 | 11958.89 |
| 3 | 4 | 40.05 |
| 4 | 6 | 23.25 |
| 5 | 8 | 73.81 |
| 6 | 9 | −24.19 |
| 7 | 11 | 24.22 |
| 8 | 14 | 29.15 |
| 9 | 16 | −15.54 |
| 10 | 18 | 0.00 |
| 11 | 20 | 0.00 |

When a finitely distant object is brought into an in-
focus

| | Wide angle | intermediate | telephoto |
|---|---|---|---|
| Object distance | 1500 | 3000 | 4400 |
| Three-unit | 0.32 | 0.33 | 0.28 |
| moving amount | | | |

(assume that a movement to an image side is positive in focusing from infinite object to finite distant object)

### Numerical Example 4

(Numerical example 4)
Unit: mm
Surface data

| Surface | | | | | effective |
|---|---|---|---|---|---|
| No. | r | d | nd | νd | diameter |
| 1 | 828.093 | 1.50 | 1.85135 | 40.1 | 24.28 |
| 2* | 15.211 | 3.00 | | | 20.42 |
| 3 | 17.953 | 2.55 | 1.92286 | 20.9 | 20.54 |
| 4 | 30.066 | (variable) | | | 19.91 |
| 5* | 12.756 | 3.50 | 1.58313 | 59.4 | 9.57 |
| 6* | −141.250 | 0.60 | | | 9.45 |
| 7 | 15.244 | 1.50 | 1.48749 | 70.2 | 8.93 |
| 8 | 24.517 | 0.80 | 1.84666 | 23.8 | 8.42 |
| 9 | 10.865 | 1.10 | | | 7.93 |
| 10 | 544.314 | 1.50 | 1.55332 | 71.7 | 7.89 |
| 11* | −16.379 | 1.05 | | | 7.81 |
| 12 (diaphragm) | ∞ | 9.79 | | | 7.24 |
| 13 | −15.480 | 2.00 | 2.00069 | 25.5 | 12.85 |
| 14 | −11.275 | 0.70 | | | 13.65 |
| 15 | −9.814 | 1.00 | 1.81000 | 41.0 | 13.66 |
| 16* | −26.209 | (variable) | | | 15.66 |
| 17 | ∞ | 1.20 | 1.51633 | 64.1 | 30.00 |
| 18 | ∞ | 0.50 | | | 30.00 |
| 19 | ∞ | 0.50 | 1.51633 | 64.1 | 30.00 |
| 20 | ∞ | | | | 30.00 |
| Image plane | ∞ | | | | |

Aspheric data

Second surface

| | | |
|---|---|---|
| K = 0.00000e+000 | A4 = 2.84446e−007 | A6 = −1.07765e−008 |
| A8 = −1.21399e−010 | A10 = −6.26209e−013 | |
| Fifth surface | | |
| K = 0.00000e+000 | A4 = −1.99398e−004 | A6 = −4.82943e−006 |
| A8 = −1.13282e−008 | A10 = −3.21840e−009 | |
| Sixth surface | | |
| K = 0.00000e+000 | A4 = −1.73735e−004 | A6 = −5.40835e−006 |
| A8 = −8.15910e−008 | | |
| Eleventh surface | | |
| K = 0.00000e+000 | A4 = 5.16045e−005 | A6 = 2.08819e−006 |
| A8 = 1.99857e−008 | | |
| Sixteenth surface | | |
| K = 0.00000e+000 | A4 = −1.67707e−005 | A6 = −1.84814e−007 |
| A8 = 1.14360e−009 | A10 = −1.76091e−011 | |

Various data

| | |
|---|---|
| Zoom ratio | 2.84 |

| | Wide angle | intermediate | telephoto |
|---|---|---|---|
| Focal length | 18.10 | 34.75 | 51.40 |
| Fno | 3.61 | 5.28 | 6.95 |
| Half angle of | | | |
| View (degree) | 36.92 | 21.37 | 14.82 |
| Image height | 13.60 | 13.60 | 13.60 |
| Lens overall | 65.53 | 58.49 | 62.53 |
| Length | | | |
| BF | 0.50 | 0.50 | 0.50 |
| d4 | 23.61 | 6.52 | 0.50 |
| d16 | 8.62 | 18.68 | 28.74 |

| | | | |
|---|---|---|---|
| incident pupil position | 18.03 | 13.59 | 11.30 |
| exit pupil position | −20.82 | −30.88 | −40.95 |
| front principal | 20.77 | 9.86 | −1.04 |
| point position | | | |
| back principal | −17.60 | −34.25 | −50.90 |
| point position | | | |

zoom lens unit data

| | | | | front | back |
|---|---|---|---|---|---|
| | | | | principal | principal |
| | starting | focal | lens | point | point |
| unit | surface | length | length | position | position |
| L1 | 1 | −32.69 | 7.05 | −0.07 | −5.14 |
| L2 | 5 | 18.45 | 10.05 | 1.10 | −6.77 |
| L3 | 13 | −43.32 | 3.70 | −0.95 | −3.24 |
| G | 17 | ∞ | 2.20 | 0.81 | −0.81 |

Single lens data

| Lens | starting surface | focal length |
|---|---|---|
| 1 | 1 | −18.22 |
| 2 | 3 | 43.85 |
| 3 | 5 | 20.23 |
| 4 | 7 | 78.51 |
| 5 | 8 | −23.68 |
| 6 | 10 | 28.76 |
| 7 | 13 | 33.51 |
| 8 | 15 | −19.91 |
| 9 | 17 | 0.00 |
| 10 | 19 | 0.00 |

When a finitely distant object is brought into an in-focus

| | Wide angle | intermediate | telephoto |
|---|---|---|---|
| Object distance | 1500 | 2800 | 4000 |
| Three-unit | 0.29 | 0.31 | 0.30 |
| moving amount | | | |

(assume that a movement to an image side is positive in focusing from infinite object to
finite distant object)

TABLE 1

| CONDI- | | | | | | |
|---|---|---|---|---|---|---|
| TIONAL | | | | | | |
| EXPRES- | LOWER | UPPER | NUMERICAL EXAMPLE | | | |
| SION | LIMIT | LIMIT | 1 | 2 | 3 | 4 |
| (1) | 0.70 | 1.20 | 0.862 | 0.941 | 0.898 | 0.755 |
| (2) | 2.50 | 6.00 | 4.351 | 4.160 | 3.946 | 5.079 |
| (3) | 1.50 | 2.40 | 1.802 | 1.826 | 1.815 | 1.806 |
| (4) | −1.80 | −0.80 | −1.082 | −1.108 | −1.196 | −1.037 |
| (5) | 0.10 | 0.80 | 0.403 | 0.425 | 0.359 | 0.390 |
| (6) | 1.50 | 3.00 | 2.5543 | 2.1968 | 1.9986 | 1.7026 |
| (7) | 0.70 | 2.00 | 1.107 | 1.073 | 1.134 | 1.112 |
| (8) | 0.60 | 1.50 | 0.956 | 0.952 | 1.023 | 1.016 |
| (9) | 1.45 | 3.00 | 1.802 | 1.811 | 1.752 | 1.771 |
| (10) | 1.00 | 2.00 | 1.414 | 1.377 | 1.478 | 1.556 |
| (11) | 1.00 | 2.00 | 1.3308 | 1.3419 | 1.3784 | 1.3570 |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2012-139649, filed Jun. 21, 2012, and 2013-096004, filed Apr. 30, 2013 which are hereby incorporated by reference herein in their entirety.

What is claimed is:

1. A zoom lens comprising, in order from an object side to an image side, a first lens unit having a negative refractive power, a second lens unit having a positive refractive power, and a third lens unit having a negative refractive power,
wherein each distance between two adjacent lens units varies during at least one of zooming and focusing,
wherein the first lens unit and the second lens unit move during zooming so that a distance between the first lens unit and the second lens unit at a telephoto end is shorter than that at a wide-angle end,
wherein the third lens unit moves during the focusing,
wherein each lens unit includes at least one positive lens and at least one negative lens, and
wherein all of the following conditional expressions are satisfied:
0.7<f1/f3<1.2;
2.5<|f3|/skw<6.0; and
1.5<|f1|/fw<2.40,
where f1 is a focal length of the first lens unit, f3 is a focal length of the third lens unit, skw is a back focus at the wide-angle end, and fw is a focal length of an entire system at the wide-angle end.

2. The zoom lens according to claim 1, wherein the following conditional expression is satisfied:
−1.8<(R1nr+R1nf)/(R1nr−R1nf)<−0.8
where R1nr is a radius of curvature of a lens surface on an image side of a negative lens having the largest absolute value of a negative refractive power in the first lens unit, and R1nf is a radius of curvature of a lens surface on an object side of the negative lens that has the largest absolute value of the negative refractive power in the first lens unit.

3. The zoom lens according to claim 1, wherein the following conditional expression is satisfied:
0.1<D1/fw<0.8
where D1 is a distance on an optical axis between a lens surface closest to an object in the first lens unit and a lens surface closest to an image in the first lens unit.

4. The zoom lens according to claim 1, wherein the following conditional expression is satisfied:
1.5<f2/D23w<3.0
where f2 is a focal length of the second lens unit, and D23w is a distance on an optical axis between a lens surface closest to an image in the second lens unit and a lens surface closest to an object in the third lens unit when an infinite object is brought into an in-focus at the wide-angle end.

5. The zoom lens according to claim 1, wherein the following conditional expression is satisfied:
0.70<|X2|/fw<2.00
where X2 is a moving amount of the second lens unit during zooming from the wide-angle end to a telephoto end.

6. The zoom lens according to claim 1, wherein the third lens unit moves to the object side during zooming from the wide-angle end to a telephoto end.

7. The zoom lens according to claim 1, wherein the following conditional expression is satisfied:
0.6<X2/X3<1.5
where X2 is a moving amount of the second lens unit during zooming from the wide-angle end to a telephoto end, and X3 is a moving amount of the third lens unit during zooming from the wide-angle end to the telephoto end when an infinite object is brought into an in-focus.

8. The zoom lens according to claim 1, wherein the following conditional expression is satisfied:
1.45<|f1|/f2<3.00
where f2 is a focal length of the second lens unit.

9. The zoom lens according to claim 1, wherein the following conditional expression is satisfied:
1.0<(β2t*β3w)/(β2w*β3t)<2.0
where β2w is a lateral magnification of the second lens unit when an infinite object is brought into an in-focus at the wide-angle end, β2t is a lateral magnification of the second lens unit when the infinite object is brought into an in-focus at a telephoto end, β3w is a lateral magnification of the third lens unit when the infinite object is brought into an in-focus at the wide-angle end, and β3t is a lateral magnification of the third lens unit when the infinite object is brought into an in-focus at the telephoto end.

10. The zoom lens according to claim 1, wherein the second lens unit and the third lens unit move with loci different from each other during zooming from the wide-angle end to a telephoto end.

11. The zoom lens according to claim 1, wherein the second lens unit and the third lens unit move as one unit during zooming from the wide-angle end to a telephoto end.

12. An image pickup apparatus comprising a zoom lens according to claim 1, and an image sensor configured to receive light of an image formed by the zoom lens.

13. The image pickup apparatus according to claim 12, wherein the following conditional expression is satisfied:
1.0<f2/Yim<2.0
where Yim is half a diagonal length of an effective image pickup plane of the image sensor, and f2 is a focal length of the second lens unit.
